(19) United States
(12) Patent Application Publication
(10) Pub. No.: US 2010/0218023 A1
(43) Pub. Date: Aug. 26, 2010

(54) INFORMATION PROCESSING APPARATUS, METHOD OF CONTROLLING THE SAME, AND STORAGE MEDIUM

(75) Inventor: Junnosuke Yokoyama, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/712,103

(22) Filed: Feb. 24, 2010

(30) Foreign Application Priority Data
Feb. 25, 2009 (JP) 2009-042223

(51) Int. Cl. G06F 12/00; G06F 17/30; G06F 1/32

(52) U.S. Cl. 713/323; 711/154; 707/758; 707/E17.014; 711/E12.001

(57) ABSTRACT

An information processing apparatus which is capable of quickly responding to a data access request from an external information processing apparatus without using an external storage device, while enabling appropriate control of the power supply to a circuit including a storage device. The storage device stores a plurality of data items. A power controller controls a state of the power supply to the storage device. A storage section stores identification information for identifying an external device permitted to access data in association with a data item stored in the storage device. The power controller causes electric power supplied to the storage device to be reduced when a CPU detects that the external device identified by identification information is not in a state capable of acquiring the data item stored in the storage device.

### BACKGROUND OF THE INVENTION

1. Field of the Invention

The present invention relates to an information processing apparatus including a storage medium and a method of controlling the same.

2. Description of the Related Art

Conventionally, there has been proposed an information processing apparatus that achieves power saving by controlling power supply to a circuit including a storage section for storing data when not in operation for a predetermined time period. However, the storage section (e.g. a hard disk drive (HDD) has a limited service life of power supply (power supply service life) dependent on the number of times of repetition of power supply and interruption thereof, and hence it is required to perform power control for suppressing power supply to other circuits while continuing the power supply to the storage section so as not to increase the number of times of interruption of the power supply.

Further, access to data in the storage section is performed after resuming the power supply, and hence a certain processing time is required before the access. Therefore, response to a file access request transmitted from an external device to the information processing apparatus is delayed if the information processing apparatus is in a power-saving mode. To solve this problem to always enable quick access to data (particularly reading of data), it is required to always supply electric power to the storage section at the expense of saving electric power so as to shorten the processing time.

As described above, the conventional information processing apparatus suffers from the problem of the power supply service life of the storage section and the problem of response to a file access request from an external device, which makes it difficult to achieve sufficient power saving.

To solve these problems, there has been proposed a method in Japanese Patent Laid-Open Publication No. 2006-53902. In this method, when a request for accessing predetermined data is transmitted to the information processing apparatus in the power-saving state, information from another server apparatus that duplicates the predetermined data for storage is used in place. By using the server apparatus as described above, the information processing apparatus can shift to the power-saving state without much concern for the above-mentioned problems of the power supply service life of the storage section and the response time to the file access request from the external device.

However, in the method proposed in Japanese Patent Laid-Open Publication No. 2006-53902, it is required to dispose the server apparatus for storing the duplicated data and always energize the server apparatus. Further, the server apparatus stores predetermined data of a plurality of information processing apparatuses in a duplicated manner, and hence requires a vast storage area corresponding to a total of storage areas of all the information processing apparatuses of the whole system. In view of these points, it is impossible to achieve sufficient power saving for the whole system.

### SUMMARY OF THE INVENTION

The present invention provides an information processing apparatus which is capable of quickly responding to a data access request from an external information processing apparatus without using an external storage device e.g. of a server, while enabling appropriate control of power supply to a circuit including a storage device and interruption thereof.

In a first aspect of the present invention, there is provided an information processing apparatus comprising a communication unit configured to communicate with external devices connected to a network, a storage device configured to store data, an electric power control unit configured to control a state of power supply to the storage device, a storage unit configured to store, in association with a data item stored in the storage device, identification information for identifying an external device capable of acquiring the data item, a detection unit configured to detect whether or not the external device identified by the identification information stored in the storage unit is in a state capable of acquiring the data item stored in the storage device, a determination unit configured to be operable when the communication unit receives an acquisition request for acquiring a data item stored in the storage device from the external device, to determine whether or not to transmit the data item associated with the acquisition request to the external device, based on the identification information stored in the storage unit in association with the data item associated with the acquisition request, and a communication control unit configured to cause the communication unit to transmit the data associated with the acquisition request to the external device, when the communication unit receives the acquisition request and when the determination unit determines that the data associated with the acquisition request be transmitted to the external device, wherein the electric power control unit causes electric power supplied to the storage device to be reduced, when the detection unit detects that the external device identified by the identification information is not in the state capable of acquiring the item data stored in the storage device.

In a second aspect of the present invention, there is provided a method of controlling an information processing apparatus including a communication unit configured to communicating with an external device connected to a network, a storage device configured to store data, an electric power control unit configured to control a state of power supply to the storage device, and a storage unit configured to store, in association with a data item stored in the storage device, identification information for identifying an external device capable of acquiring the data item, the method comprising detecting whether or not the external device identified by the identification information stored in the storage unit is in a state capable of acquiring the data item stored in the storage device, determining when the communication unit receives an acquisition request for acquiring a data item stored in the storage device from the external device, whether or not to transmit the data item associated with the acquisition request to the external device, based on the identification information stored in the storage unit in association with the data item associated with the acquisition request, causing the communication unit to transmit the data associated with the acquisition request to the external device, when the communication unit receives the acquisition request and when it is determined that the data associated with the acquisition request be transmitted to the external device, and causing electric power supplied to the storage device to be reduced, when it is detected that the external device identified by the identification information is not in the state capable of acquiring the item data stored in the storage device.

In a third aspect of the present invention, there is provided a computer-readable storage medium that stores a program for causing a computer to execute a method of controlling an information processing apparatus including a communication unit configured to communicating with an external device connected to a network, a storage device configured to store data, an electric power control unit configured to control a state of power supply to the storage device, and a storage unit configured to store, in association with a data item stored in the storage device, identification information for identifying an external device capable of acquiring the data item, wherein the method comprises detecting whether or not the external device identified by the identification information stored in the storage unit is in a state capable of acquiring the data item stored in the storage device, determining when the communication unit receives an acquisition request for acquiring a data item stored in the storage device from the external device, whether or not to transmit the data item associated with the acquisition request to the external device, based on the identification information stored in the storage unit in association with the data item associated with the acquisition request, causing the communication unit to transmit the data associated with the acquisition request to the external device, when the communication unit receives the acquisition request and when it is determined that the data associated with the acquisition request be transmitted to the external device, and causing electric power supplied to the storage device to be reduced, when it is detected that the external device identified by the identification information is not in the state capable of acquiring the item data stored in the storage device.

According to the present invention, it is possible to quickly respond to a data access request from an external device on a network without using an external storage device e.g. of as a server, and shift the operation mode of a circuit including a storage device to a power-saving mode under suitable conditions.

Further features of the present invention will become apparent from the following description of exemplary embodiments (with reference to the attached drawings).

### BRIEF DESCRIPTION OF THE DRAWINGS

FIG. 1 is a schematic view of a system including an information processing apparatus according to a first embodiment of the present invention.

FIG. 2 is a block diagram of the FIG. 1 information processing apparatus.

FIG. 3 is a view of a data management table used by the information processing apparatus according to the first embodiment.

FIG. 4 is a flowchart of a file transfer process executed by an external device.

FIG. 5 is a flowchart of a file storage process executed by the information processing apparatus.

FIG. 6 is a view of a print configuration screen.

FIG. 7 is a view of a file storage configuration screen.

FIG. 8 is a flowchart of a file request and reception process executed by the external device.

FIG. 9 is a flowchart of a requested file transmission executed by the information processing apparatus.

FIG. 10 is a flowchart of a process executed by the information processing apparatus for shifting an operation mode thereof to a power-saving mode.

FIG. 11 is a flowchart of a process executed by the information processing apparatus for cancelling the power-saving mode thereof.

FIG. 12 is a view of a data management table used by an information processing apparatus according to a second embodiment of the present invention.

FIG. 13 is a flowchart of a file transfer process executed by an external device.

FIG. 14 is a flowchart of a file storage process executed by the information processing apparatus according to the second embodiment.

FIG. 15 is a view of a file storage configuration screen used in the second embodiment.

FIG. 16 is a flowchart of a requested file transmission executed by the information processing apparatus according to the second embodiment.

FIG. 17 is a flowchart of a process executed by the information processing apparatus according to the second embodiment for shifting the operation mode thereof to a power-saving mode.

FIG. 18 is a flowchart of a process executed by the information processing apparatus for cancelling the power-saving mode thereof.

FIG. 19 is a view of a data management table used by an information processing apparatus according to a third embodiment of the present invention.

FIG. 20 is a flowchart of a file transfer process executed by an external device.

FIG. 21 is a flowchart of a file storage process executed by the information processing apparatus according to the third embodiment.

FIG. 22 is a view of a file storage configuration screen used in the third embodiment.

FIG. 23 is a flowchart of a requested file transmission process executed by the information processing apparatus according to the third embodiment.

FIG. 24 is a flowchart of a process executed by the information processing apparatus according to the third embodiment for shifting the operation mode thereof to a power-saving mode.

FIG. 25 is a flowchart of a process executed by the information processing apparatus for cancelling the power-saving mode thereof.

FIG. 26 is a continuation of FIG. 25.

### DETAILED DESCRIPTION OF THE EMBODIMENTS

The present invention will now be described in detail below with reference to the accompanying drawings showing embodiments thereof.

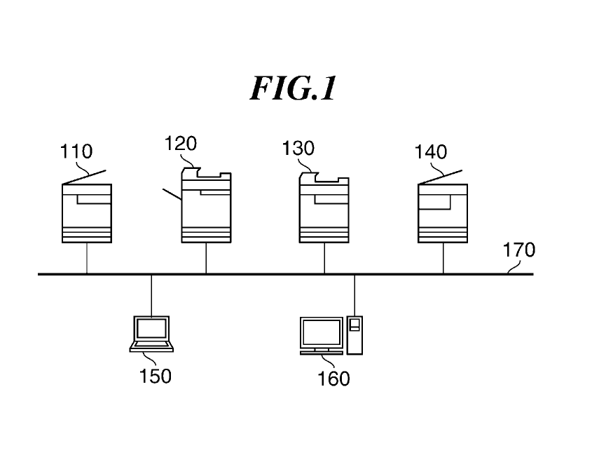

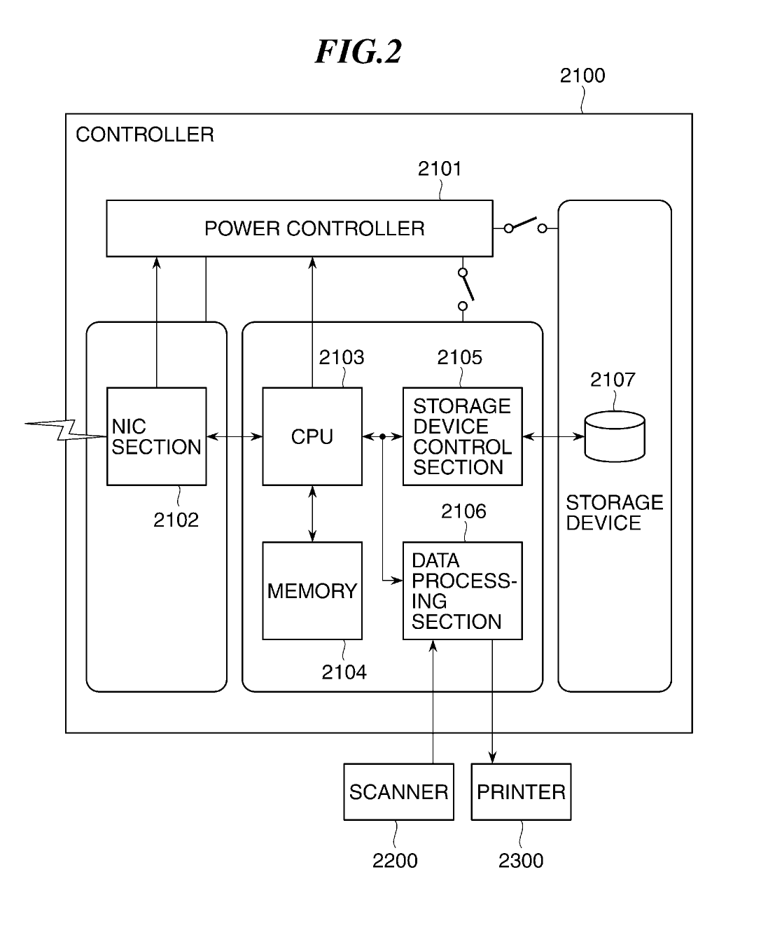

FIG. 1 is a schematic view of a system including an information processing apparatus according to a first embodiment of the present invention. FIG. 2 is a block diagram of the FIG. 1 information processing apparatus.

Referring to FIG. 2, the information processing apparatus 110 is comprised of a controller 2100, a scanner device 2200 and a printer device 2300. The controller 2100 includes a storage device 2107. The storage device 2107 stores a plurality of data items therein. The data items stored in the storage device 2107 can be accessed from external devices, such as external information processing apparatuses 120, 130 and 140, and external PC devices 150 and 160, connected to a network 170 via an NIC (Network Interface Card) section 2102 (see FIG. 1). Similarly, data items stored in the storage devices of the external information processing apparatuses 120, 130 and 140 can be accessed from the information processing apparatus 110. The NIC section 2102 functions as a communication unit used when the information processing apparatus 110 communicates with the external apparatuses (the external information processing apparatuses 120, 130 and 140, and the external PC devices 150 and 160). A CPU 2103 functions as a communication control unit for controlling the communication unit.

The information processing apparatus 110 is operable in a plurality of power modes different in power consumption. The operation mode of the information processing apparatus 110 is controlled between the plurality of power modes by increasing or decreasing the supply of electric power to the storage device 2107 and the CPU 2103 using a power controller 2101. The plurality of power modes include a normal power mode, a data access standby mode and a power-saving mode, mentioned here in descending order of power consumption.

When the information processing apparatus 110 is caused to operate in the normal power mode, the power controller 2101 controls electric power such that it is supplied to the storage device 2107, the CPU 2103, a memory section 2104, a data processing section 2106 and a storage device control section 2105, respectively.

On the other hand, when the information processing apparatus 110 is caused to operate in the data access standby mode, the power controller 2101 controls electric power such that it is supplied to the storage device 2107 while cutting off the supply of electric power to the CPU 2103, the memory section 2104, the data processing section 2106 and the storage device control section 2105.

Further, when the information processing apparatus 110 is caused to operate in the power-saving mode, the power controller 2101 cuts off the supply of electric power to the storage device 2107, the CPU 2103, the memory section 2104, the data processing section 2106 and the storage device control section 2105.

Even when the information processing apparatus 110 is operating in the power-saving mode, only the NIC section 2102 is supplied with electric power by the power controller 2101, whereby it is possible to respond to a power recovery request for changing the operation mode of the information processing apparatus 110 to the normal power mode via the network 170. When the power-saving mode shifts to the normal power mode in response to the power recovery request, the power controller 2101 resumes the supply of electric power to the CPU 2103, the memory section 2104 and the data processing section 2106, for performing required data processing in associated sections.

In the data access standby mode, the power controller 2101 supplies electric power to the storage device 2107 to thereby maintain a state in which processing, such as spin-up of the storage device 2107, is not required. When there is issued a request for storing data in the storage device 2107, the power controller 2101 supplies electric power to the CPU 2103 and the storage device control section 2105. The CPU 2103 and the storage device control section 2105 perform processing for storing data in the storage device 2107.

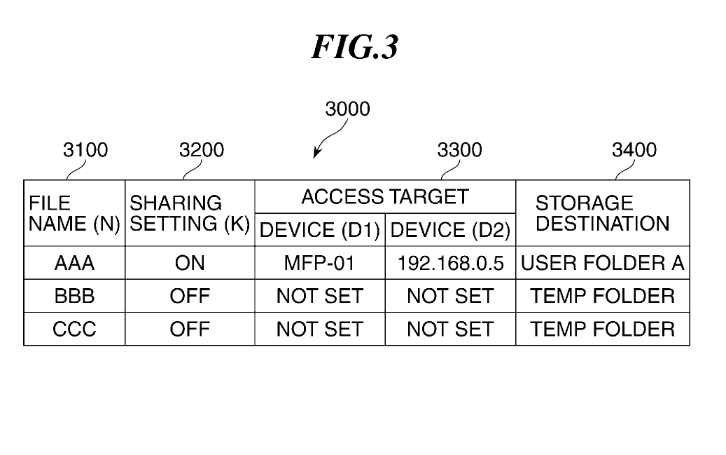

FIG. 3 is a view of a data management table used by the information processing apparatus 110 according to the first embodiment.

To store data in the storage device 2107, the information processing apparatus 110 generates the data management table 3000 illustrated in FIG. 3, and stores the data management table 3000 in a storage section (not shown), such as a flash memory, different from the storage device 2107. The data management table 3000 stores file name information 3100, sharing setting information 3200, access target information 3300, configured by a user and information on a storage destination 3400 where data is stored. The sharing setting information corresponds to information on a share flag (K), referred to hereinafter. The access target information 3300 includes address information, such as ID information or IP address, of a device (apparatus) which is permitted to access stored data (hereinafter referred to as an “access-permitted device”) as identification information for identifying the access-permitted device. Further, the access target information 3300 may include a MAC (Media Access Control) address, a device-specific number or the like of the device, in place of the ID information and the IP address. Further, one or a plurality of devices may be designated as access-permitted devices. Now, the term “access-permitted devices” are intended to mean external devices (the external information processing apparatuses 120, 130 and 140, and the external PC devices 150 and 160) which are capable of acquiring data stored in the storage device 2107.

A description will be given by taking an example of a file name “AAA”. Data of the file name “AAA” whose sharing setting is “ON” is stored in a “user folder A” to store a setting for permitting access only from a device (D1) having an ID of “MFP-01” and a device (D2) having an IP address of “192.168.0.5”.

Here, the device (D1) and the device (D2) are each generically referred to as an “access-permitted device (D)”. Further, the term “ON” of the sharing setting is intended to mean that file access from any of the external devices is permitted, and a term “OFF” of the sharing setting is intended to mean that no file access from any external device is permitted.

(A) File Storage Process

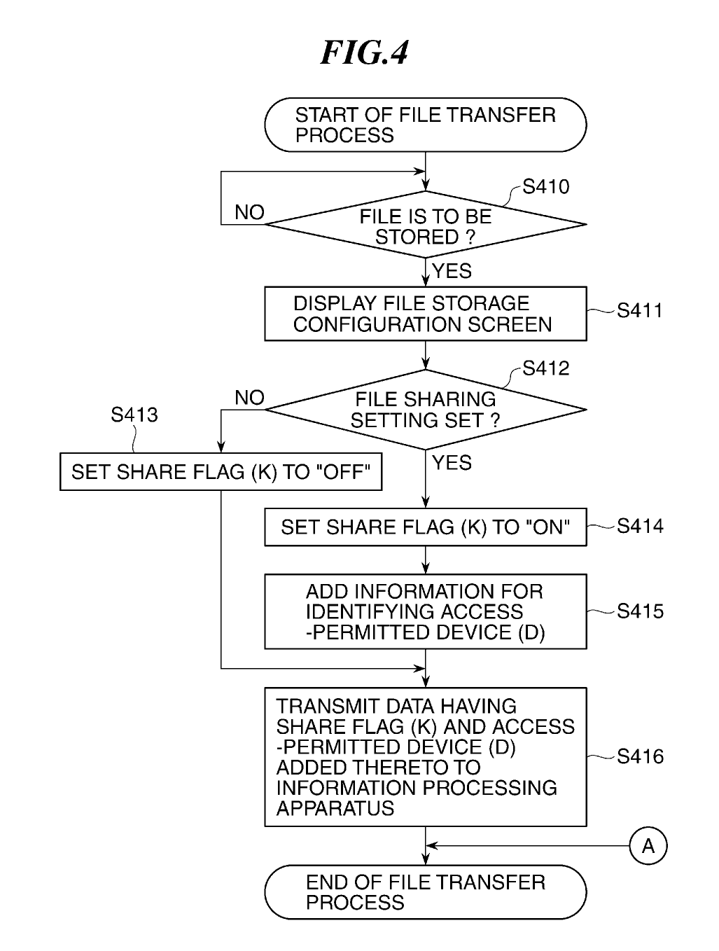

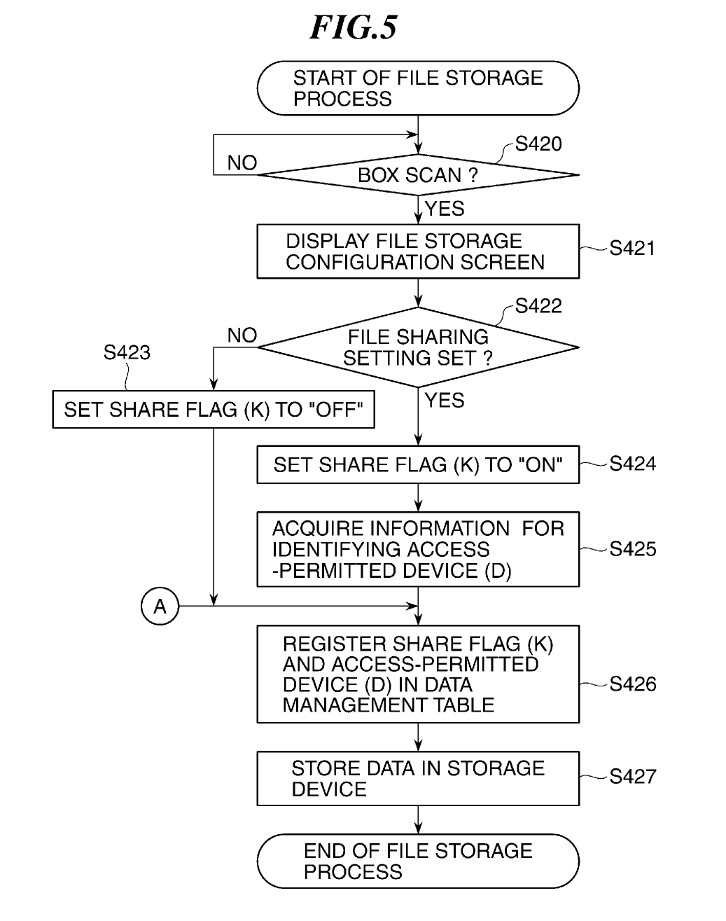

First, processing performed until a file is stored in the storage device 2107 will be described with reference to FIGS. 4 and 5.

FIGS. 4 and 5 are flowcharts of a file storage-related process executed by the system including the information processing apparatus according to the first embodiment, in which FIG. 4 shows a file transfer process executed by an external device, and FIG. 5 shows a file storage process executed by the information processing apparatus.

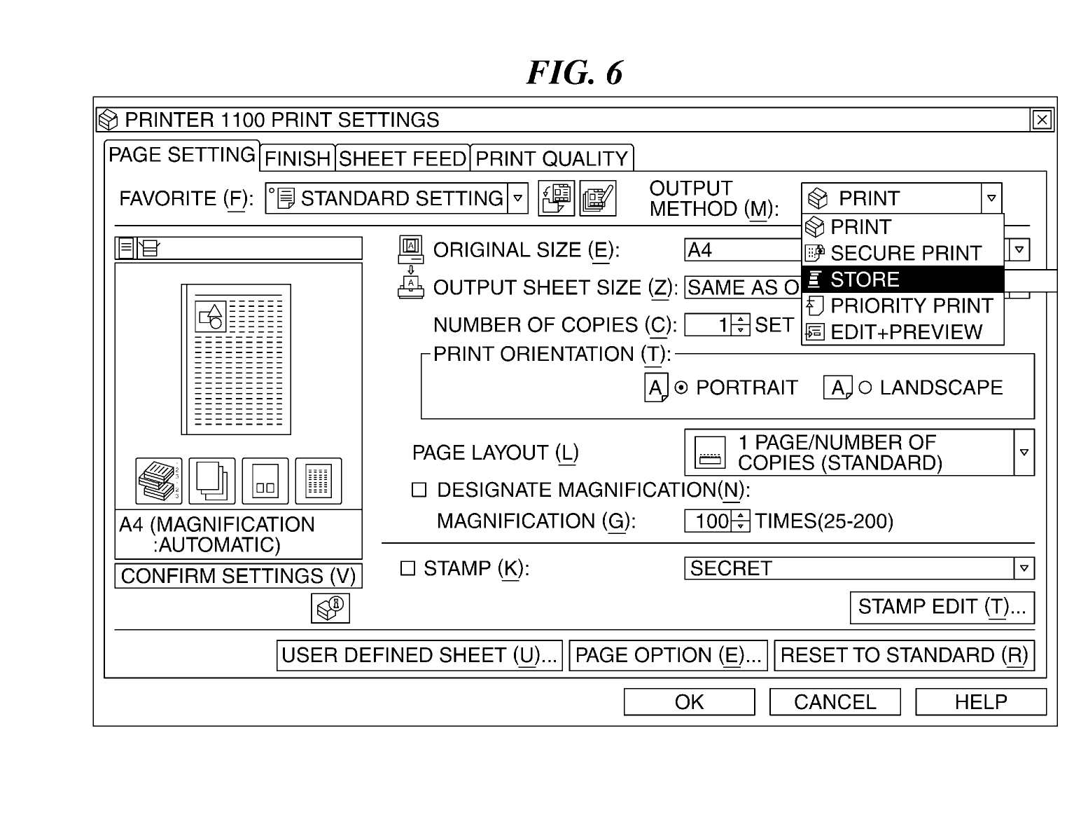

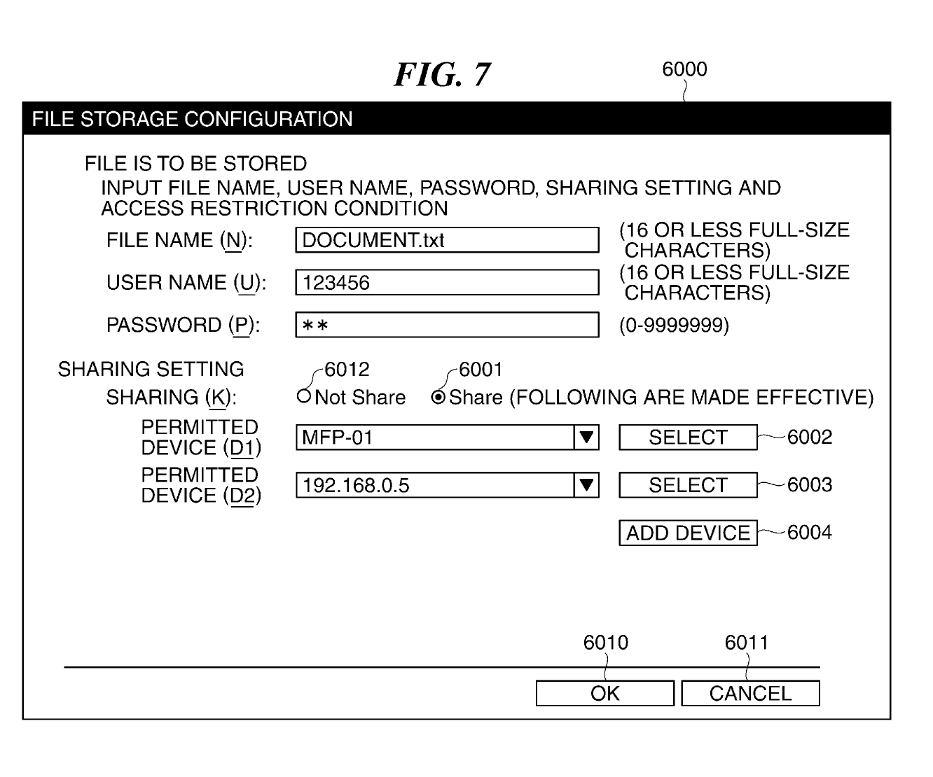

Referring to FIG. 4, when the storing of a file e.g. from the external PC device 150 or 160 in the storage device 2107 (hereinafter referred to as “file transfer”) is performed, the file transfer process is started by a driver in the external PC device (PC driver). The PC driver detects that the user has selected storage of the file by selecting “storage” as an “output method” on a print configuration screen illustrated in FIG. 6 (step S410). Then, a file storage configuration screen 6000 as illustrated in FIG. 7 is displayed (step S411).

On the file storage configuration screen, it is possible to designate not only a file name (N) of the transferred file, a user name (U) of an administrator user (U) and a password (P) of the user but also ON or OFF of the sharing setting and an access-permitted device. These designated information items are stored in header information added to data when the data is transmitted.

When a sharing-ON button 6001 is selected (step S412) on the file storage configuration screen in FIG. 7, the PC driver sets a share flag (K) to “ON” in the header information (step S414). Then, the PC driver adds information (D) for identifying an access-permitted device selected by clicking a selection button 6002 or 6003 to the header information (step S415). Whenever an increase in the number of access-permitted devices is desired, the user can add one by clicking a device add button 6004.

Further, when a sharing-OFF button 6012 is selected (step S412), the PC driver sets the share flag (K) to “OFF” in the header information (step S413).

When the user terminates the configuration on the file storage configuration screen 6000 and clicks an OK button 6010, the PC driver adds the share flag (K) and the access-permitted device (D) to the header information and transmits the resulting data to the information processing apparatus 110 (step S416). This terminates the operation by the PC driver.

Referring to FIG. 5, upon reception of the data from the PC driver, the CPU 2103 of the information processing apparatus 110 registers the information stored in the header in the data management table 3000 (step S426 in FIG. 5), and stores the received data in the storage device 2107 (step S427).

Now, a description will be given of a process performed when image data read by the information processing apparatus 110 using the scanner device 2200 is stored in the storage device 2107 (hereinafter referred to as “the box scan”).

When the CPU 2103 of the information processing apparatus 110 detects on an operation screen (not shown) that the box scan is set (step S420), the CPU 2103 displays the file storage configuration screen 6000 as illustrated in FIG. 7 (step S421). When the sharing-ON button 6001 is selected by the user on the file storage configuration screen 6000 (step S422), the CPU 2103 sets the share flag (K) to “ON” (step S424) and acquires information on the access-permitted device (D) (step S425). After that, the CPU 2103 registers these items of information on the share flag (K) and the access-permitted device (D) in the data management table 3000 (step S426) and stores image data read from an original on an original platen glass, not shown, in the storage device 2107 (step S427).

On the other hand, in the above-mentioned step S422, when the sharing-OFF button 6012 is selected by the user (step S422), the CPU 2103 sets the share flag (K) to “OFF” (step S423) and does not acquire the information on the access-permitted device (D). Then, the CPU 2103 registers the information in the data management table 3000 (step S426).

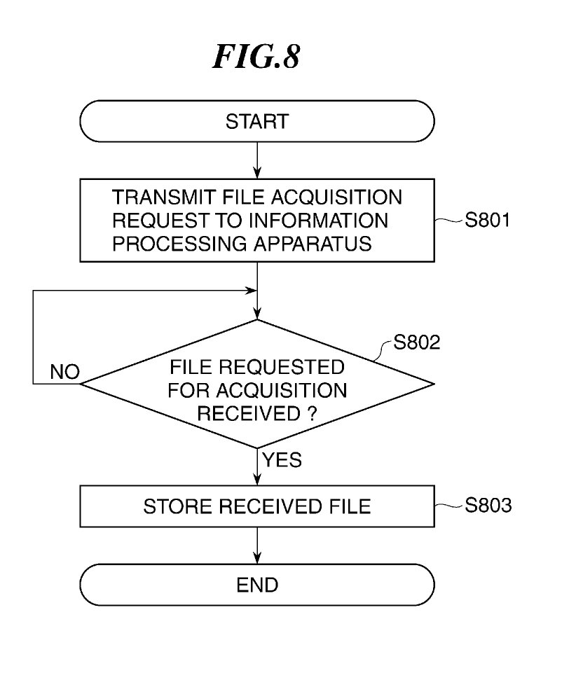

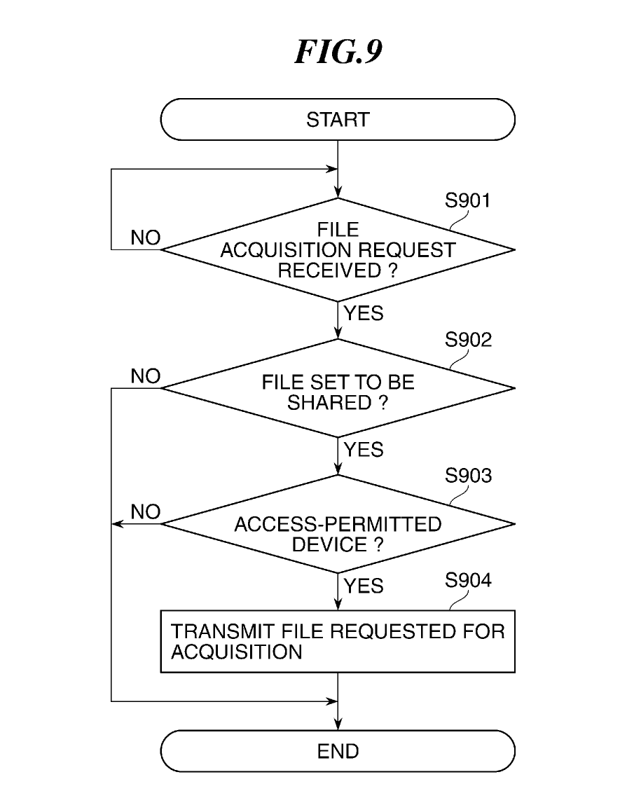

Next, a process for transmitting a file stored in the storage device 2107 from the information processing apparatus 110 to an external device (e.g. the external information processing apparatus 120) will be described with reference to FIGS. 8 and 9. FIG. 8 is a flowchart of a file request and reception process executed by the external device, and FIG. 9 is a flowchart of a requested file transmission process executed by the information processing apparatus.

Referring to FIG. 8, when acquiring a file (data) stored in the storage device 2107 of the information processing apparatus 110, the external device (e.g. the external information processing apparatus 120) transmits a file acquisition request to the information processing apparatus 110 (step S801). Here, it is assumed that when a file acquisition request is transmitted, information for identifying a file associated with the file acquisition request (e.g. the file name AAA appearing in FIG. 3) is transmitted from the external device to the information processing apparatus 110.

The external device determines whether or not the file requested for acquisition has been received (step S802). If the file has been received, the file is stored in a storage section (memory such as an HDD) of the external device.

Referring to FIG. 9, the CPU 2103 of the information processing apparatus 110 determines whether or not the file acquisition request transmitted in the step S801 in FIG. 8 has been received (step S901). If the CPU 2103 has determined that the file acquisition request has been received, the process proceeds to a step S902.

In the step S902, the CPU 2103 refers to the data management table 3000 and determines whether or not the file requested for acquisition by the file acquisition request received in the step S901 is a file which is set to be shared (sharing-ON). If it is determined that the file is set to be shared (e.g. in the case where the file having the file name AAA is requested for acquisition), the process proceeds to a step S903, whereas if not, the present process is immediately terminated.

In the step S903, the CPU 2103 refers to the data management table 3000 and determines whether or not the external device that has transmitted the file acquisition request is an access-permitted device. If the external device is an access-permitted device, the process proceeds to a step S904. For example, if the device ID of the external information processing apparatus 120 as an external device is “MFP-01”, the CPU 2103 determines that the apparatus 120 is an access-permitted device.

In the step S904, the CPU 2103 transmits the file requested for acquisition to the external information processing apparatus 120 since the file requested for acquisition by the external information processing apparatus 120 as an external device is set to be shared, and the external information processing apparatus 120 is an access-permitted device.

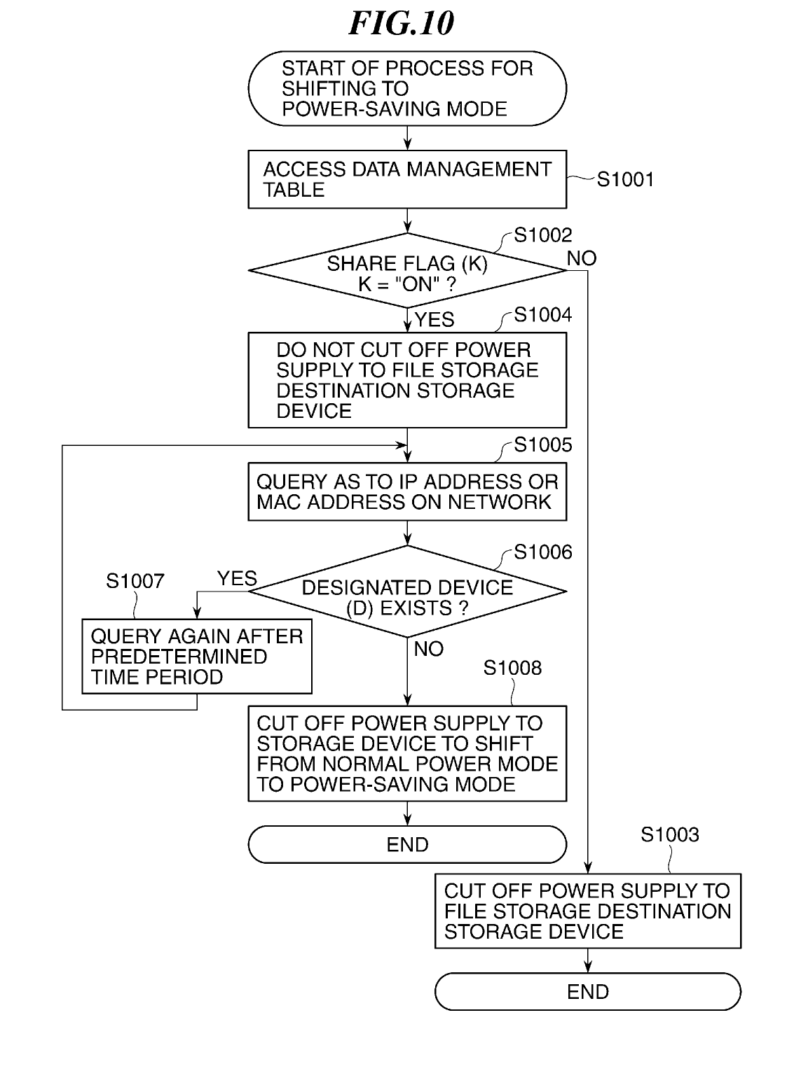

When the information processing apparatus 110 that has stored the data set to be shared in the data management table 3000 shifts the operation mode (power mode) to the power-saving mode after the lapse of time without being operated, a process shown in FIG. 10 is performed.

FIG. 10 is a flowchart of the process executed by the information processing apparatus 110 for shifting the operation mode thereof to the power-saving mode.

The information processing apparatus 110 accesses the data management table 3000 (step S1001), and detects whether or not there exists data whose share flag (K) is set to “ON” (step S1002). If there exists no data whose share flag (K) is set to “ON”, the information processing apparatus 110 shifts to a power mode in which the power supply to the storage device 2107 is cut off (step S1003).

If there exists data whose share flag (K) is set to “ON”, the information processing apparatus 110 does not cut off the power supply to the storage device 2107 (step S1004), and queries the external information processing apparatuses 120, 130 and 140, and the external PC devices 150 and 160 on the network 170 as to states thereof (step S1005). Here, for example, the information processing apparatus 110 queries the external devices as to IP addresses or MAC addresses thereof for identifying devices.

The information processing apparatus 110 detects whether or not the access-permitted device (D) registered in the data management table 3000 exists among the external devices known by the query (step S1006). As the result of the detection, if the access-permitted device (D) registered in the data management table 3000 is not detected, the CPU 2103 determines that the registered access-permitted device (D) is not in a state capable of acquiring the file (N) from the storage device 2107. In this case, the CPU 2103 determines that there is no possibility of the file (N) being accessed, and instructs the power controller 2101 to cut off the power supply to the storage device 2107. The power controller 2101 instructed by the CPU 2103 cuts off the power supply to the storage device 2107, thereby causing the operation mode of the information processing apparatus 110 to shift from the normal power mode to the power-saving mode (step S1008). On the other hand, as the result of the query, if the registered access-permitted device (D) is detected, the CPU 2103 determines that there is still a possibility of the file (N) being accessed, and continues the power supply to the storage device 2107. Then, after the lapse of a predetermined time period (step S1007), the CPU 2103 performs the query again (step S1005). When the registered access-permitted device (D) ceases to be detected, the CPU 2103 causes the power controller 2101 to cut off the power supply to the storage device 2107 (step S1008). Although in the step S1008, the power supply to the storage device 2107 is completely cut off, the power supply to part of the storage device 2107 may be cut off so as to shift the operation mode of the information processing apparatus 110 to such a reduced power consumption mode in which the storage device 2107 cannot store data.

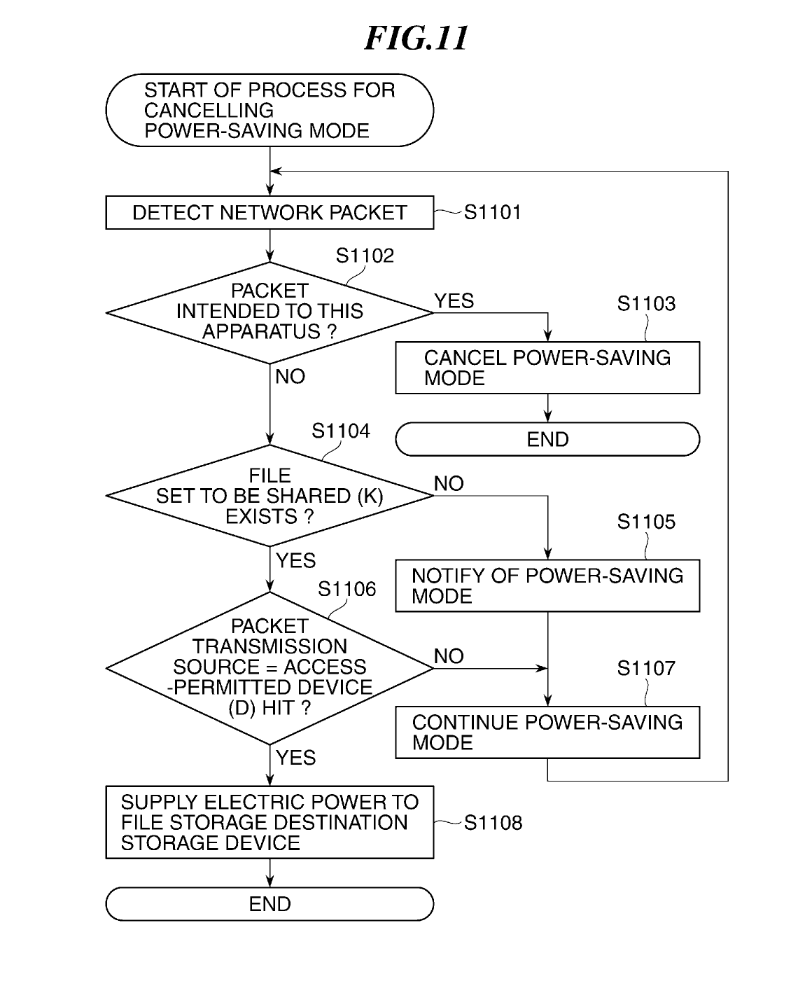

To cancel the power-saving mode, the information processing apparatus 110 performs a process shown in FIG. 11.

FIG. 11 is a flowchart of the process executed by the information processing apparatus 110 for cancelling the power-saving mode thereof.

The information processing apparatus 110 monitors packet data on the network 170 even in the power-saving mode (step S1101). It is a general practice that if data, such as a print request, which is intended to be sent to the present information processing apparatus 110, is received (step S1102), the information processing apparatus 110 recovers from the power-saving mode (step S1103), for performing print processing. In addition, the following process as well is carried out in the present embodiment.

The information processing apparatus 110 in the power-saving mode detects packet data on the network 170 (step S1101). When the packet data is not print data transmitted to the information processing apparatus 110, the information processing apparatus 110 reads out information on the sharing setting (K) from the data management table 3000 (step S1104).

If there is no file set to be shared in the data management table 3000, the information processing apparatus 110 notifies the transmission source of the network packet that it is in the power-saving mode (step S1105), and continues the power-saving mode (step S1107). If there is a file set to be shared in the data management table 3000, the information processing apparatus 110 determines whether or not in the data management table 3000, the file is associated with an access-permitted device (D) having an IP address or a MAC address of the transmission source of the network packet (step S1106). If the file is not associated with the access-permitted device (D), the information processing apparatus 110 continues the power-saving mode, whereas if the file is associated with the access-permitted device (D), the information processing apparatus 110 supplies electric power to the storage device 2107 (step S1108), whereby preparation for the access-permitted device (D) to access the data is completed.

The first embodiment provides the following advantageous effects:

(1) Each data item stored in the storage device 2107 is configured as to sharing setting and an access-permitted device, and if no data stored therein is set to be shared, it is determined that there is no possibility of the data stored therein being accessed. This makes it possible to cut off the power supply to the storage device 2107 and the storage device control section 2105.

(2) If there comes to be no access-permitted device detected among external devices connected to the network 170, it is determined that there is no possibility of the stored data being accessed. This makes it possible to cut off the power supply to the storage device 2107 and the storage device control section 2105.

(3) As long as an access-permitted device is detected on the network 170, electric power is supplied to the storage device 2107 and the storage device control section 2105, and there is no need to perform a process for resuming the supply of electric power so as to read out a file. This makes it possible to quickly respond to a request for accessing the data stored in the storage device 2107.

(4) Since it is possible to determine the possibility of access to the data, it is possible to reduce the number of times of unnecessary power supply and the number of times of unnecessary interruption of the power supply to the storage device 2107.

Next, a second embodiment of the present invention will be described. Although in the first embodiment, permission to data access is identified on a device (access-permitted device) basis, the second embodiment is distinguished from the first embodiment in that permission to data access is identified on a user basis.

The configuration of a system including an information processing apparatus according to the second embodiment, and the internal configuration of the information processing apparatus are the same as those of the first embodiment described above with reference to FIGS. 1 and 2. Therefore, elements corresponding to those in the first embodiment are denoted by identical reference numerals, and description thereof is omitted.

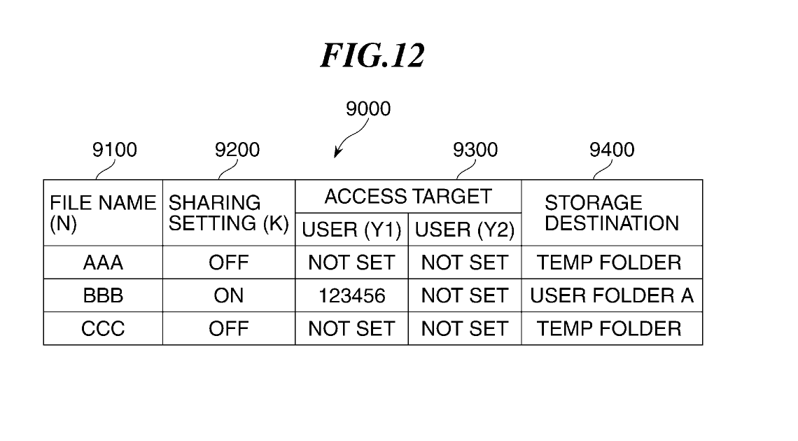

FIG. 12 is a view of a data management table used by the information processing apparatus 110 according to the second embodiment of the present invention.

When storing data in the storage device 2107, the information processing apparatus 110 generates a data management table 9000 illustrated in FIG. 12, and stores the data management table 9000 in a storage section (not shown), such as a flash memory, different from the storage device 2107. The data management table 9000 stores sharing setting information 9200 and access target information 9300, set by the user. The access target information 9300 includes e.g. ID information of the user as information for identifying the user who is permitted to access stored data (hereinafter referred to as an “access-permitted user”). Further, the access target information 9300 may include not only the personal ID of the user but also the group ID and the biometric authentication data of the user. Further, not only one user but also two or more users may be designated.

A description will be given by taking an example of a file name “BBB”. Data of the file name “BBB” whose sharing setting is set to “ON” is stored in the “user folder A” and a setting for permitting access thereto only from a user having a user ID “123456” is stored. Now, the terms “ON” of the sharing setting and “OFF” of the same are intended to mean the same as described above in the first embodiment.

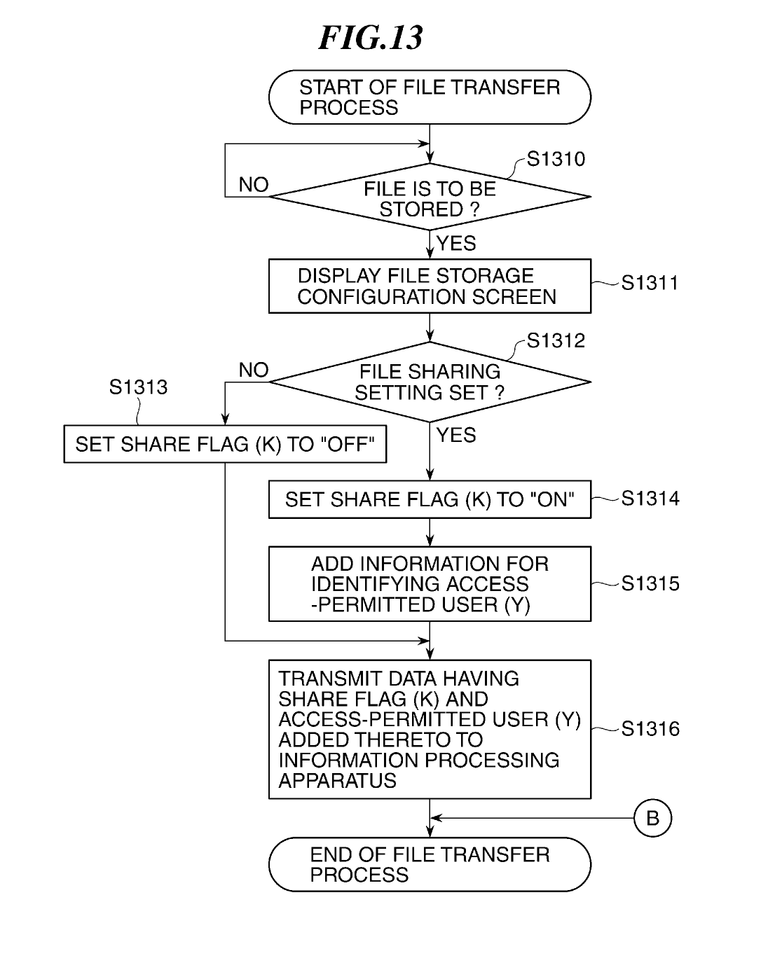

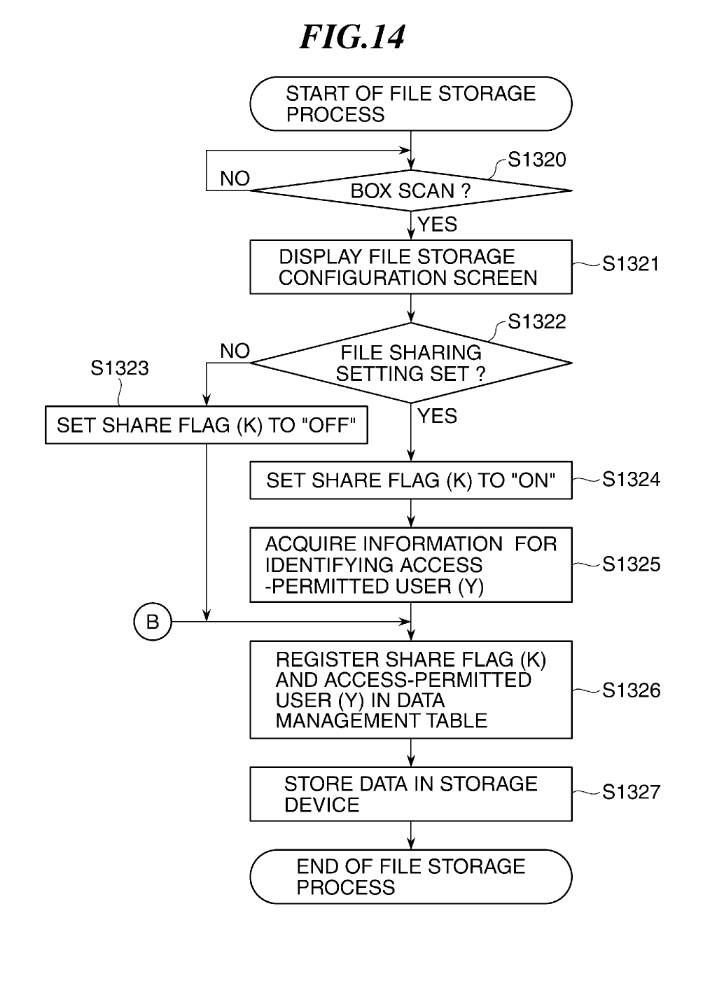

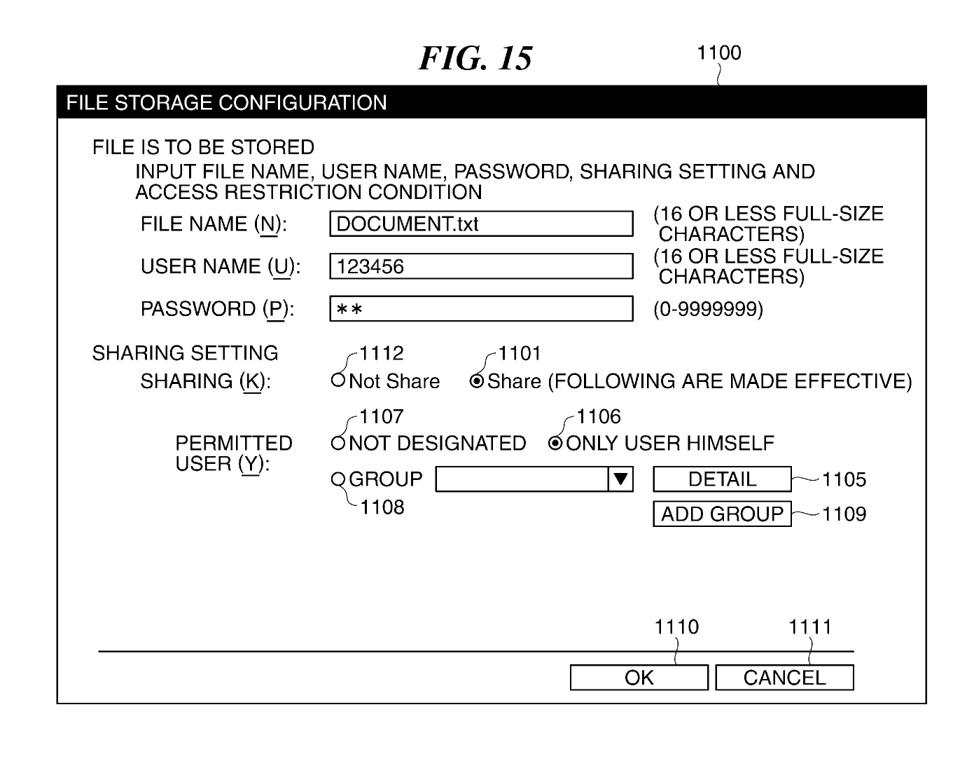

FIGS. 13 and 14 are flowcharts of a file storage-related process executed by the system including the information processing apparatus according to the second embodiment, in which FIG. 13 shows a file transfer process executed by an external device, and FIG. 14 shows a file storage process executed by the information processing apparatus. FIG. 15 is a view of a file storage configuration screen used in the second embodiment.

In the present embodiment, processing performed until a file is stored in the storage device 2107 is accomplished by the processes illustrated in FIGS. 13 and 14 using the configuration screens in FIGS. 6 and 15. However, basically, the processes are similar to those illustrated in FIGS. 4 and 5 which use the configuration screens in FIGS. 6 and 7 in the above-described first embodiment.

More specifically, according to the present embodiment, in the FIG. 13 process executed on the external device side, steps S1310 to S1316 correspond to the FIG. 4 steps S410 to S416 according to the first embodiment, respectively. Basically, the process executed in the FIG. 13 steps S1310 to S1316 according to the present embodiment can be described by replacing the “access-permitted device” appearing in the FIG. 4 steps S410 to S416 by the “access-permitted user”.

The following description will be mainly given of different points in the file storage-related process according to the second embodiment from those of the first embodiment.

When data from the external PC devices 150 and 160 is stored in the storage device 2107, the PC driver displays, after executing the step S1310 which is the same as the step S410 in FIG. 4, the file storage configuration screen 1100 illustrated in FIG. 15 (step S1311).

On this file storage configuration screen 1100, it is possible to designate not only a file name (N), a user name (U), a password (P) and ON or OFF of the sharing setting but also an access-permitted user.

When a sharing-ON button 1101 is selected, the PC driver sets the share flag (K) to “ON” (step S1314). Then, the PC driver adds information (Y) for identifying an access-permitted user designated by clicking a user designation button 1106, 1107 or 1108 to header information (step S1315). Whenever an increase in the number of access-permitted users is desired, the user can add one by clicking a group addition button 1109.

When the user terminates the configuration on the file storage configuration screen 1100 and clicks an OK button 1110, the PC driver adds the share flag (K) and the access-permitted user (Y) to the header information and transmits the resulting data to the information processing apparatus 110 (step S1316), followed by terminating the operation by the PC driver.

Upon reception of the data from the PC driver, the CPU 2103 of the information processing apparatus 110 registers the information stored in the header in the data management table 9000 (step S1326 in FIG. 14), and stores the received data in the storage device 2107 (step S1327).

On the other hand, in the case of the box scan, steps S1320 to S1324 in FIG. 14 are identical to the respective steps S420 to 5424 appearing in FIG. 5.

On the file storage configuration screen 1100 in FIG. 15, if the share flag (K) is set to “ON” (step S1324), the CPU 2103 acquires information items of the access-permitted user (Y) (step S1325). Then, the CPU 2103 registers these items of information on the share flag (K) and the access-permitted user (Y) in the data management table 9000 (step S1326), and stores image data read from an original on the original platen glass, not shown, in the storage device 2107 (step S1327).

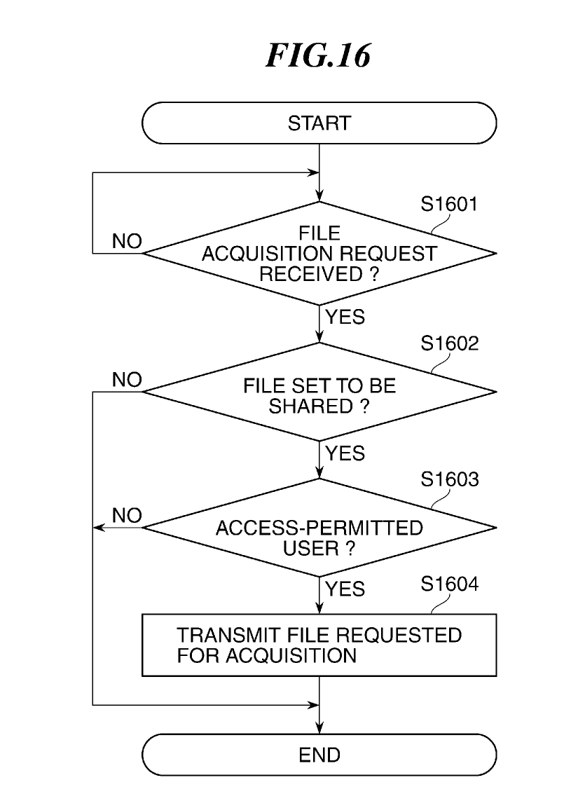

Next, a process for transmitting a file stored in the storage device 2107 from the information processing apparatus 110 to an external device (e.g. the external information processing apparatus 120) will be described with reference to FIG. 16. FIG. 16 is a flowchart of the file transmission process executed by the information processing apparatus according to the second embodiment.

A file request and reception process executed by the external device (the external information processing apparatus 120 or the like) is the same as described above with reference to FIG. 8. Although in the first embodiment, the device ID (MFP-01) for identifying the external information processing apparatus 120 that transmits the file acquisition request is added to the file acquisition request, the second embodiment is distinguished from the first embodiment in that a user name (U) for identifying a user who has logged in to the external information processing apparatus 120 that transmits the file acquisition request is added to the file acquisition request.

The CPU 2103 of the information processing apparatus 110 determines whether or not the file acquisition request transmitted in the step S801 in FIG. 8 has been received (step S1601). If the CPU 2103 has determined that the file acquisition request has been received, the process proceeds to a step S1602.

In the step S1602, the CPU 2103 refers to the data management table 9000 and determines whether or not the file requested for acquisition by the file acquisition request received in the step S1601 is a file set to be shared. If it is determined that the file is set to be shared (e.g. in the case where the file having the file name BBB is requested for acquisition), the process proceeds to a step S1603, whereas if not, the present process is immediately terminated.

In the step S1603, the CPU 2103 refers to the data management table 9000 and determines whether or not the user having logged in to the device having transmitted the file acquisition request is an access-permitted user. If the user is an access-permitted user, the process proceeds to a step S1604. For example, if the user ID of the user having logged in to the external information processing apparatus 120 as an external device is “123456”, the CPU 2103 determines that the user is an access-permitted user.

In the step S1604, the CPU 2103 transmits the file requested for acquisition to the external information processing apparatus 120 since the file requested for acquisition by the external information processing apparatus 120 as an external device is set to be shared, and the user having logged in to the external information processing apparatus 120 is an access-permitted user.

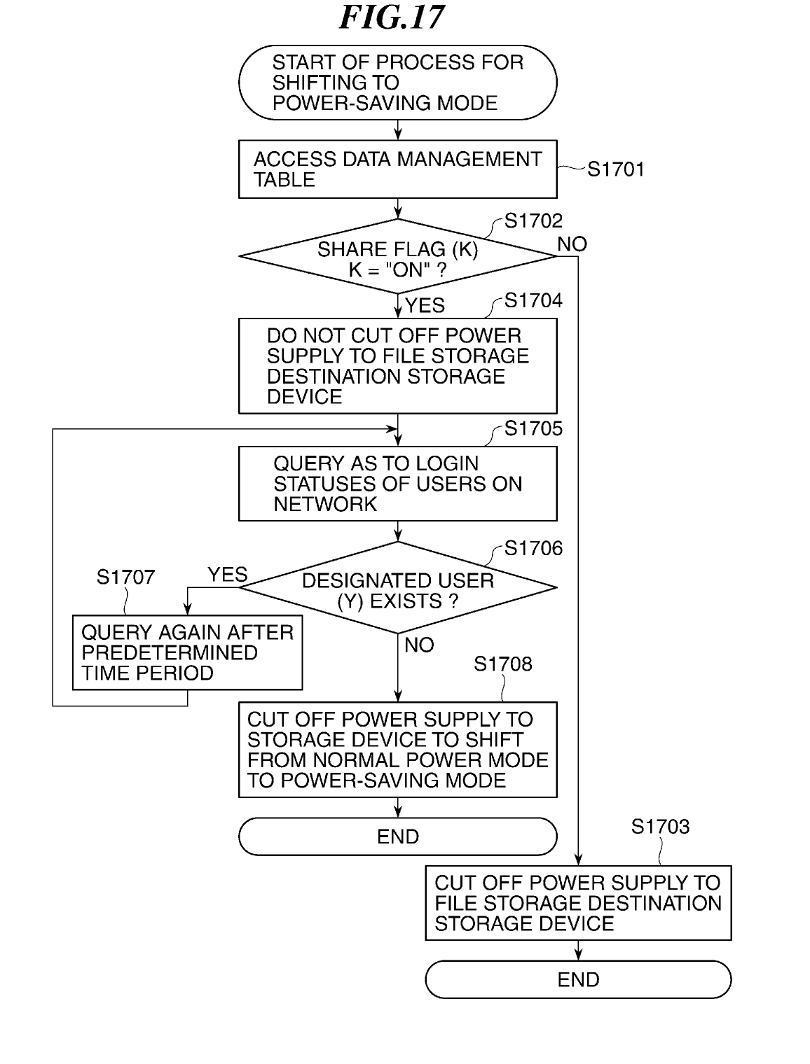

When the information processing apparatus 110 that has stored the data set to be shared in the storage section shifts the power mode to the power-saving mode after the lapse of time without being operated, a process shown in FIG. 17 is performed.

FIG. 17 is a flowchart of a process executed by the information processing apparatus according to the second embodiment for shifting the operation mode thereof to a power-saving mode.

In this process, steps S1701 to S1704 are identical to the respective steps S1001 to S1004 appearing in FIG. 10.

If there exists data whose share flag (K) is set to “ON”, the CPU 2103 of the information processing apparatus 110 does not cut off the power supply to the storage device 2107 (step S1704), and then the process proceeds to a step S1705. In the step S1705, the CPU 2103 queries the external information processing apparatuses 120, 130 and 140, and the external PC devices 150 and 160 on the network 170 as to states thereof.

Here, the CPU 2103 makes a query as to user login information of users having logged in to the external devices so as to identify the access-permitted user. Based on the result of the query, the CPU 2103 detects whether or not the user (Y) registered in the data management table 9000 exists (step S1706). If the user (Y) is not detected, that is, if the user (Y) does not exist, the CPU 2103 detects that the access-permitted user is not in a state capable of acquiring the file (N) from the storage device 2107. In this case, the CPU 2103 determines that there is no possibility of the file (N) being accessed, and instructs the power controller 2101 to cut off the power supply to the storage device 2107. The power controller 2101 instructed by the CPU 2103 cuts off the power supply to the storage device 2107, thereby causing the operation mode of the information processing apparatus 110 to shift from the normal power mode to the power-saving mode (step S1708). On the other hand, as the result of the query, if the registered user (Y) is detected, the CPU 2103 determines that there is still a possibility of the file (N) being accessed, and continues the power supply to the storage device 2107.

Then, after the lapse of a predetermined time period (step S1707), the CPU 2103 performs the query again (step S1705). When there comes to be no registered user (Y)) detected, the CPU 2103 causes the power controller 2101 to cut off the power supply to the storage device 2107 (step S1708). Although in the step S1708, the power supply to the storage device 2107 is completely cut off, the power supply to part of the storage device 2107 may be cut off so as to shift the information processing apparatus 110 to such a reduced power consumption mode in which the storage device 2107 cannot store data.

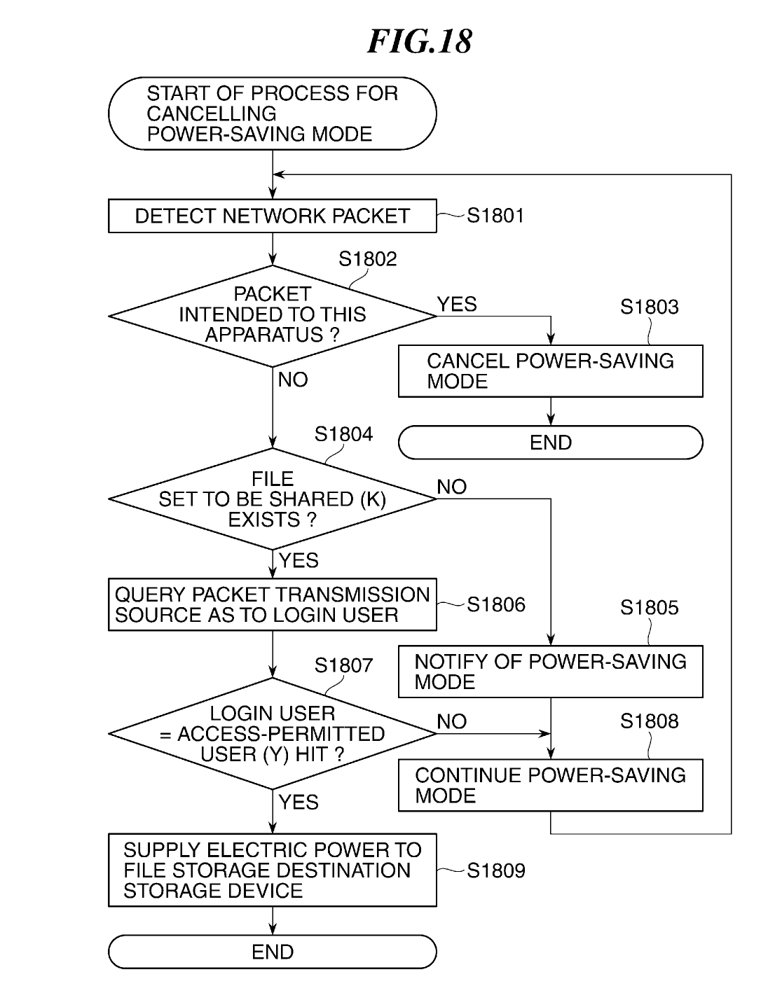

FIG. 18 is a flowchart of a process executed by the information processing apparatus for cancelling the power-saving mode thereof.

In this process, steps S1801 to S1805 are identical to the respective steps S1101 to S1105 described above with reference to FIG. 11 in the first embodiment.

In the step S1804, the CPU 2103 determines whether or not there is a file set to be shared. If there is no file set to be shared, the process proceeds to a step S1805. In the step S1805, the CPU 2103 notifies the transmission source of the network packet that the information processing apparatus 110 is in the power-saving mode, and continues the power-saving mode (step S1808).

On the other hand, if there is a file set to be shared, the CPU 2103 requests the packet transmission source to transmit data of the login user (step S1806). Then, the CPU 2103 determines whether or not the login user corresponds to the access-permitted user set in the data management table 9000 (step S1807). If the login user does not correspond to the access-permitted user, the CPU 2103 continues the power-saving mode (step S1808), whereas if the login user corresponds to the access-permitted user, the CPU 2103 supplies electric power to the storage device 2107 (step S1809), whereby preparation for the access-permitted user (Y) to access the data is completed.

The second embodiment provides the following advantageous effects:

(1) Each data item stored in the storage device 2107 is configured as to sharing setting and an access-permitted user, and if no data stored therein is set to be shared, it is determined that there is no possibility of the data stored therein being accessed. This makes it possible to cut off the power supply to the storage device 2107 and the storage device control section 2105.

(2) If there comes to be no access-permitted user detected among external devices connected to the network 170, it is determined that there is no possibility of the stored data being accessed. This makes it possible to cut off the power supply to the storage device 2107 and the storage device control section 2105.

(3) As long as an access-permitted user is detected on the network 170, electric power is supplied to the storage device 2107 and the storage device control section 2105, and there is no need to perform a process for resuming the supply of electric power so as to read out a file. This makes it possible to quickly respond to a request for accessing the data stored in the storage device 2107.

(4) Since it is possible to determine the possibility of access to the data, similarly to the first embodiment, it is possible to reduce the number of times of unnecessary power supply and the number of times of unnecessary interruption of the power supply to the storage device 2107.

(5) As distinct from the first embodiment that designates permission to access to data on a device basis, in the second embodiment, permission to access to data can be designated on a user basis, so that it is possible to access a shared file from a device which is not registered by the user, which improves user-friendliness.

Next, a third embodiment of the present invention will be described. Although the description has been given, in the first embodiment, of the example where permission to access is identified on a device basis, and in the second embodiment, of the example where permission to access is identified on a user basis, the third embodiment is distinguished from the first and second embodiments in that permission to access is identified on a basis of a combination of a device and a user.

The configuration of a system including an information processing apparatus according to the third embodiment, and the internal configuration of the information processing apparatus are the same as those of the first embodiment, described above with reference to FIGS. 1 and 2. Therefore, elements corresponding to those in the first embodiment are denoted by identical reference numerals, and description thereof is omitted.

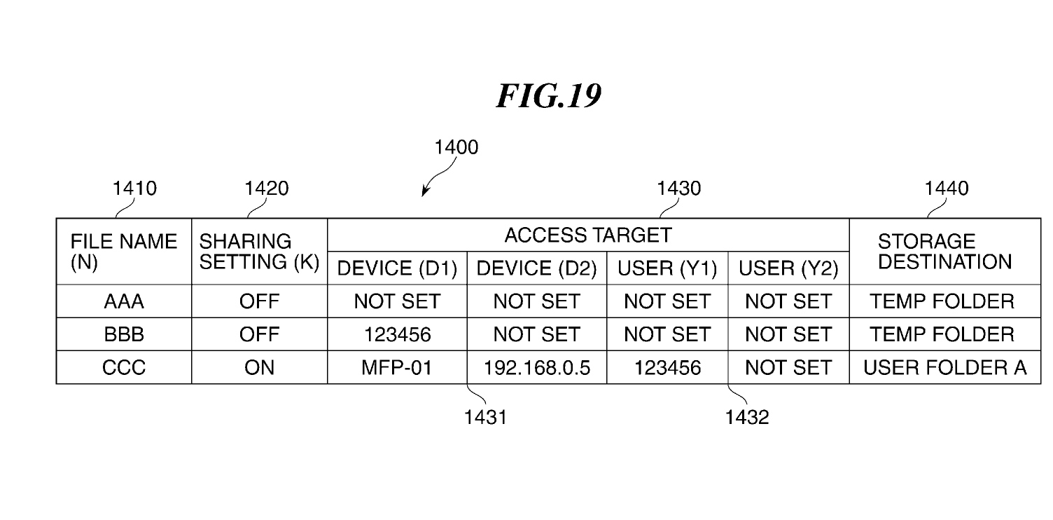

FIG. 19 is a view of a data management table used by the information processing apparatus 110 according to the third embodiment of the present invention.

When storing data in the storage device 2107, the information processing apparatus 110 generates a data management table 1400 illustrated in FIG. 19, and stores the data management table 1400 in a storage section (not shown), such as a flash memory, different from the storage device 2107.

The data management table 1400 stores sharing setting information 1420 and access target information 1430, set by a user. In the access target information 1430, there are set access-permitted devices described above in the first embodiment and access-permitted users described above in the second embodiment. Further, the number of the devices and that of the users may be two or more, respectively. Further, only either of the devices and the users may be set, and the remainder may be not.

A description will be given by taking an example of a file name “CCC”. Data of the file name “CCC” whose sharing setting is set to “ON” is stored in the “user holder A”. Then, settings for permitting access only from a device (D1) having an ID of “MFP-01”, a device (D2) having an IP address of “192.168.0.5”, and a user ID of “123456” are stored. Now, the terms “ON” of the sharing setting and “OFF” of the same are intended to mean the same as described above in the first embodiment.

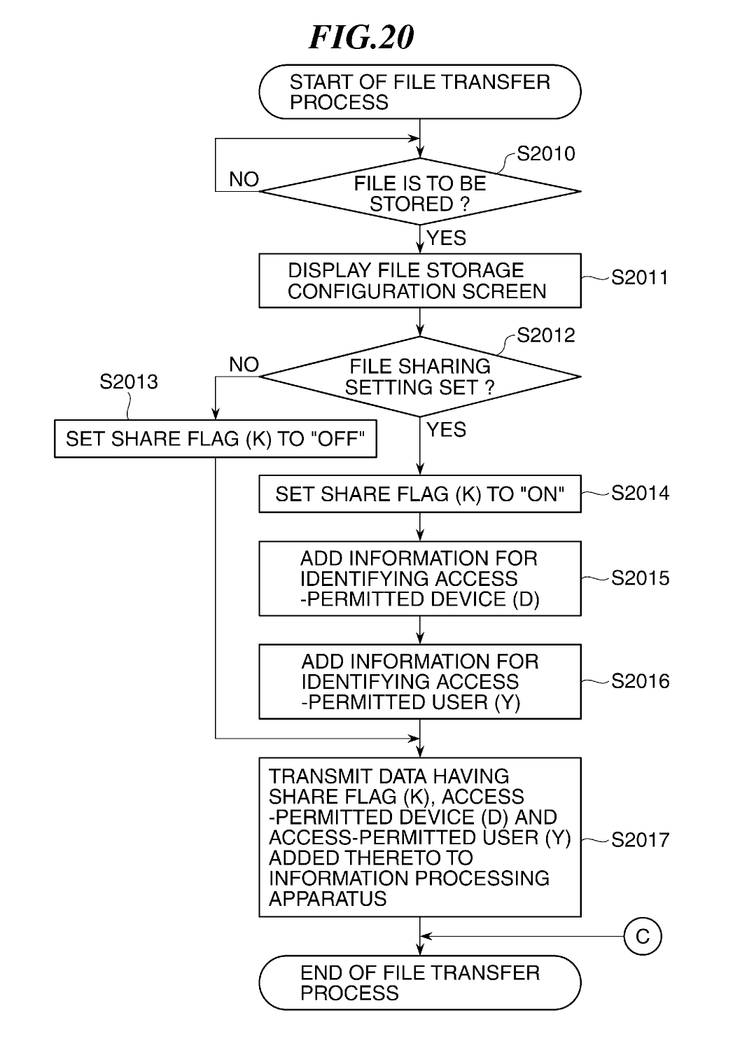

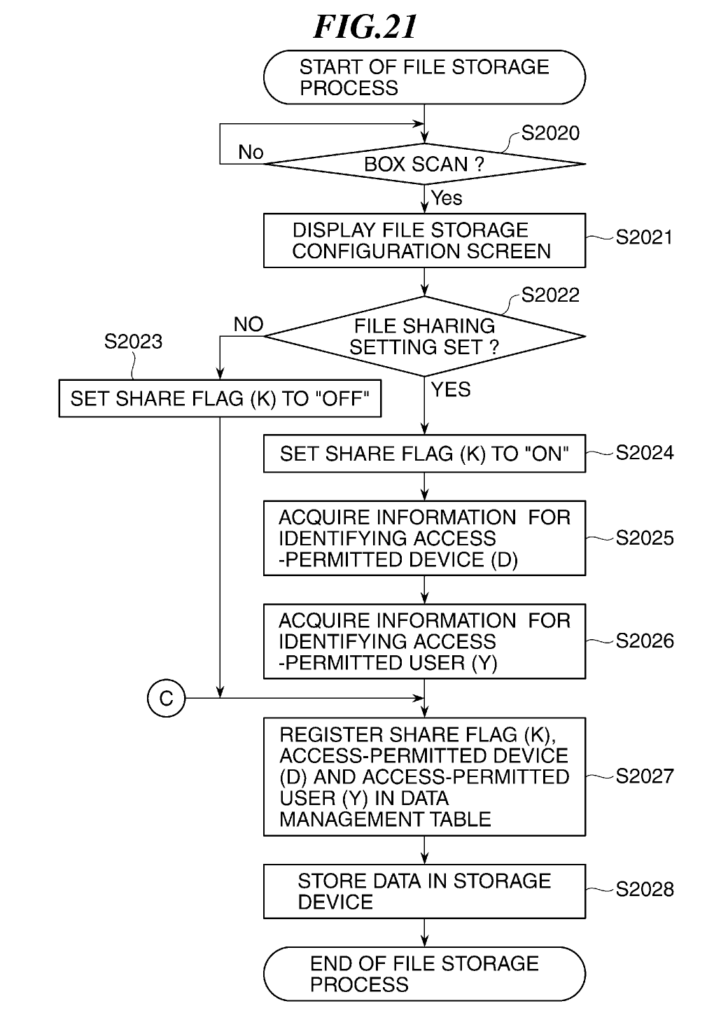

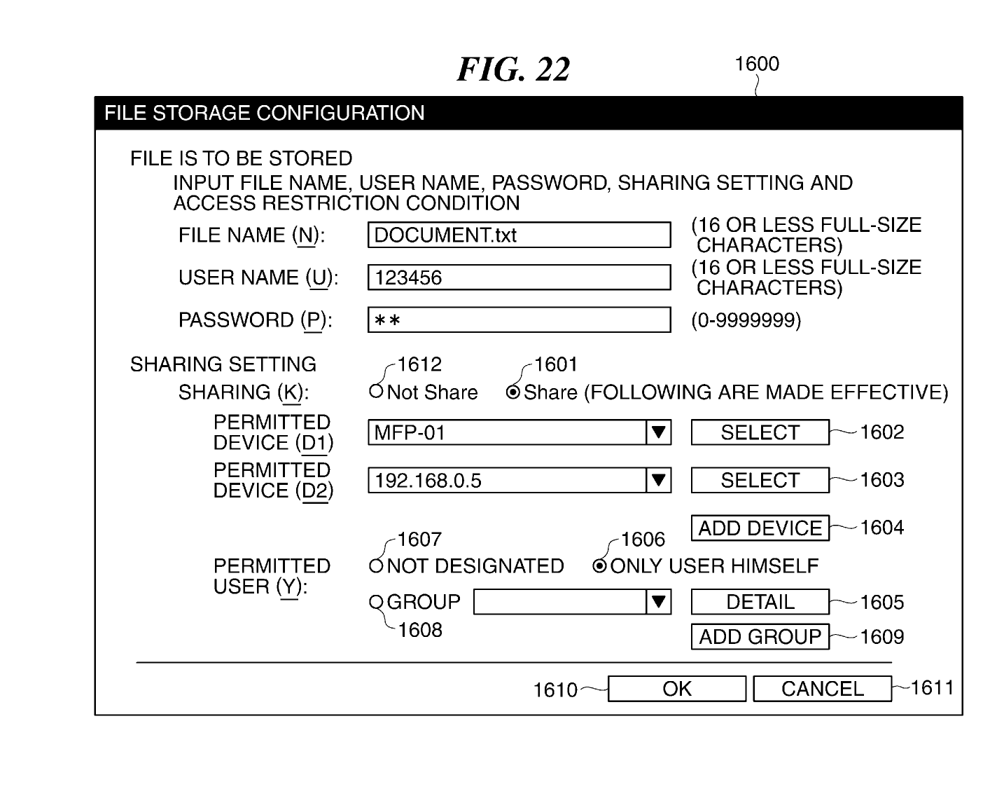

FIGS. 20 and 21 are flowcharts of a file storage-related process according to the third embodiment, in which FIG. 20 shows a file transfer process executed by an external device, and FIG. 21 shows a file storage process executed by the information processing apparatus. FIG. 22 is a view of a file storage configuration screen used in the third embodiment.

In the present embodiment, in processing performed until a file is stored in the storage device 2107, steps S2010 to S2014 are identical to the respective steps S410 to S414 appearing in FIG. 4 in the first embodiment.

In the step S2014, when a sharing-ON button 1601 appearing in FIG. 22 is selected by the user, the PC driver sets the share flag (K) to “ON” in the header information. Next, the PC driver adds information (D) for identifying an access-permitted device selected using a selection button 1602 or 1603 to the header information (step S2015).

Then, the PC driver adds information (Y) for identifying an access-permitted user designated using a user designation button 1606, 1607 or 1608 to the header information (step S2016). Whenever an increase in the number of access-permitted devices is desired, the user can add one by clicking a device addition button 1604, whereas whenever an increase in the number of access-permitted users, the user can add one by clicking a group addition button 1609.

When the user terminates the configuration on the file storage configuration screen 1600 and clicks an OK button 1610, the PC driver adds the share flag (K), the access-permitted device (D), and the access-permitted user (Y) to the header information, and transmits the resulting data to the information processing apparatus 110 (step S2017). This terminates the operation by the PC driver.

Upon reception of the data from the PC driver, the information processing apparatus 110 registers the information stored in the header in the data management table 1400 in FIG. 19 (step S2027), and stores the received data in the storage device 2027 (step S2028).

On the other hand, in the case of the box scan, steps S2020 to S2024 in FIG. 21 are identical to the respective steps S420 to 5424 in FIG. 5.

On the file storage configuration screen 1600 in FIG. 22, if the share flag (K) is set to “ON” (step S2024), the CPU 2103 acquires information items of the access-permitted device (D) (step S2025) and information items of the access-permitted user (Y) (step S2026). Then, the CPU 2103 registers these items of information on the share flag (K), the access-permitted device (D) and the access-permitted user (Y) in the data management table 1400 (step S2027), and stores image data read from an original on the original platen glass, not shown, in the storage device 2107 (step S2028).

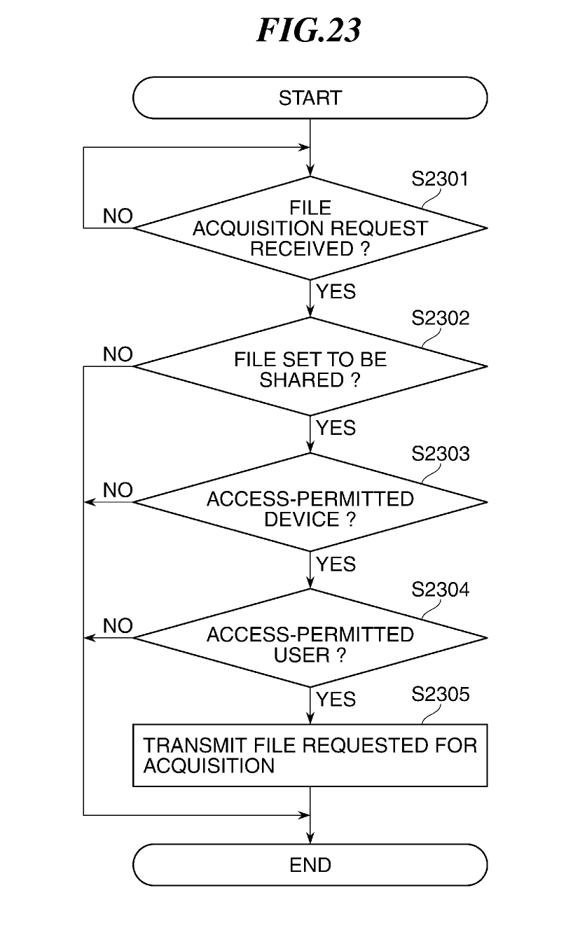

Next, a process for transmitting a file stored in the storage device 2107 from the information processing apparatus 110 to an external device (e.g. the external information processing apparatus 120) will be described with reference to FIG. 23. FIG. 23 is a flowchart of a file transmission process executed by the information processing apparatus according to the third embodiment.

A file request and reception process executed by the external device (the external information processing apparatus 120 or the like) is the same as described above with reference to FIG. 8. Although in the first embodiment, the device ID (MFP-01) for identifying the external information processing apparatus 120 that transmits the file acquisition request is added to the file acquisition request, the third embodiment is distinguished from the first embodiment in that not only the device ID (MFP-01) for identifying the external information processing apparatus 120 that transmits the file acquisition request but also a user name (U) for identifying the user who has logged in to the external information processing apparatus 120 are added to the file acquisition request.

The CPU 2103 of the information processing apparatus 110 determines whether or not the file acquisition request transmitted in the step S801 in FIG. 8 has been received (step S2301). If the CPU 2103 has determined that the file acquisition request has been received, the process proceeds to a step S2302.

In the step S2302, the CPU 2103 refers to the data management table 1400 and determines whether or not the file requested for acquisition by the file acquisition request received in the step S2301 is a file set to be shared. If it is determined that the file is set to be shared (e.g. in the case where the file having the file name CCC is requested for acquisition), the process proceeds to a step S2303, whereas if not, the present process is immediately terminated.

In the step S2303, the CPU 2103 refers to the data management table 1400 and determines whether or not the device having transmitted the file acquisition request is an access-permitted device. If the device having transmitted the file acquisition request is an access-permitted device, the process proceeds to a step S2304. For example, if the device ID of the external information processing apparatus 120 as an external device is “MFP-01”, the CPU 2103 determines that the apparatus 120 is an access-permitted device.

In the step S2304, the CPU 2103 refers to the data management table 1400 and determines whether or not the user having logged in to the device having transmitted the file acquisition request is an access-permitted user. If the user is an access-permitted user, the process proceeds to a step S2305. For example, if the user ID of the user having logged in to the external information processing apparatus 120 as an external device is “123456”, the CPU 2103 determines that the user is an access-permitted user.

In the step S2305, the CPU 2103 transmits the file requested for acquisition to the external information processing apparatus 120 since the file requested for acquisition by the external information processing apparatus 120 as an external device is set to be shared, the external information processing apparatus 120 is an access-permitted device, and the user having logged in to the external information processing apparatus 120 is an access-permitted user.

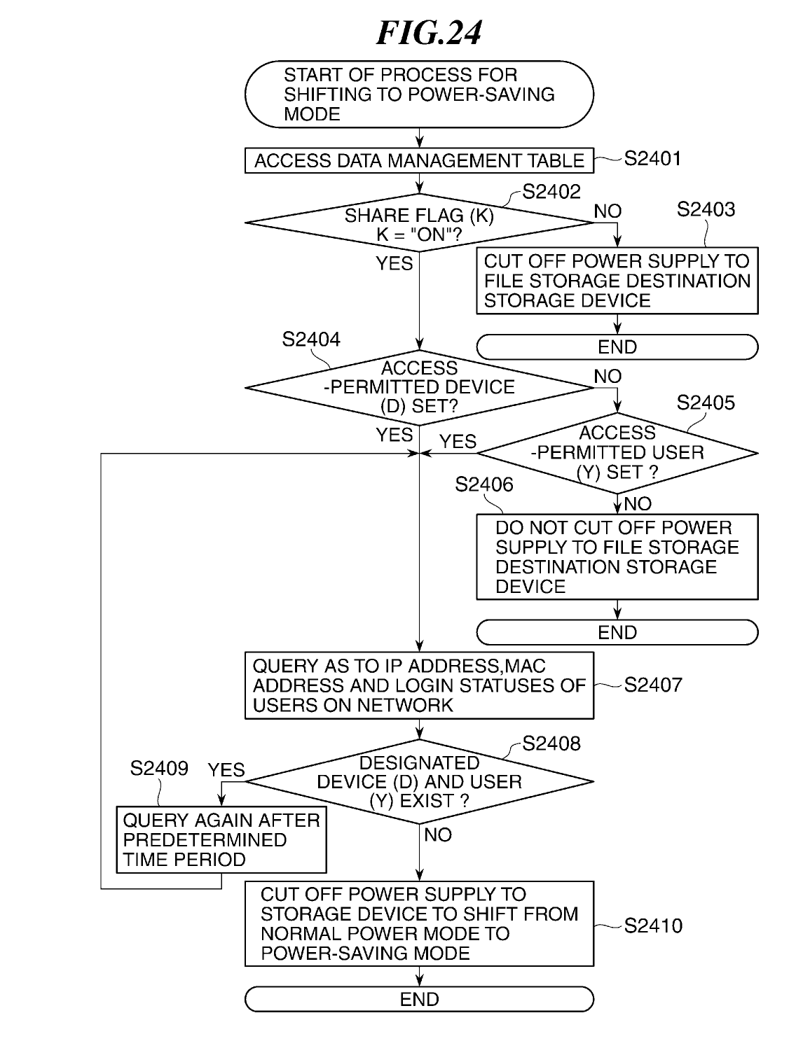

When the information processing apparatus 110 that has stored the data set to be shared in the storage section shifts the power mode to the power-saving mode after the lapse of time without being operated, a process shown in FIG. 24 is performed.

FIG. 24 is a flowchart of the process executed by the information processing apparatus according to the third embodiment for shifting the operation mode thereof to a power-saving mode.

The CPU 2103 of the information processing apparatus 110 accesses the data management table 1400 (step S2401), and detects whether or not there exists data whose share flag (K) is set to “ON” (step S2402). If there exists no data whose share flag (K) is set to “ON”, the information processing apparatus 110 shifts to a power mode for cutting off the power supply to the storage device 2107 (step S2403).

If there exists data whose share flag (K) is set to “ON”, the CPU 2103 detects whether or not the data has an access-permitted device (D) set thereto (step S2404). If the data has no access-permitted device (D) set thereto, the CPU 2103 detects whether or not the data has an access-permitted user (Y) set thereto (step S2405).

If the data has neither an access-permitted device (D) nor an access-permitted user (Y) set thereto, the CPU 2103 does not cut off the power supply to the storage device 2107 (step S2406). If the data has at least one of an access-permitted device (D) and an access-permitted user (Y) set thereto, the CPU 2103 performs processing in a step S2407. In the step S2407, the CPU 2103 queries the external information processing apparatuses 120, 130 and 140, and the external PC devices 150 and 160 on the network 170 as to states thereof. For example, for identifying the access-permitted device (D), the CPU 2103 makes a query as to IP addresses or MAC addresses of the external devices, whereas for identifying the access-permitted user (Y), the CPU 2103 makes a query as to user login information of users having logged in to the external devices.

Based on the results of the queries, the CPU 2103 detects whether or not the access-permitted device (D) or the access-permitted user (Y) registered in the data management table 1400 exists (step S2408). If neither the access-permitted device (D) nor the access-permitted user (Y) exists, that is, if neither the access-permitted device (D) nor the access-permitted user (Y) is detected, the CPU 2103 detects that the access-permitted device (D) or an external device to which the access-permitted user (Y) has logged in is not in a state capable of acquiring the file (N) from the storage device 2107. In this case, the CPU 2103 determines that there is no possibility of the file (N) being accessed, and instructs the power controller 2101 to cut off the power supply to the storage device 2107. The power controller 2101 instructed by the CPU 2103 cuts off the power supply to the storage device 2107, thereby causing the operation mode of the information processing apparatus 110 to shift from the normal power mode to the power-saving mode (step S2410).

On the other hand, as the results of the queries, if the registered access-permitted device (D) or access-permitted user (Y) is detected, the CPU 2103 determines that there is still a possibility of the file (N) being accessed, and continues the power supply to the storage device 2107. Then, after the lapse of a predetermined time period (step S2409), the CPU 2103 performs the queries again (step S2407). If there comes to be neither the access-permitted device (D) nor access-permitted user (Y) which is detected, the CPU 2103 causes the power controller 2101 to cut off the power supply to the storage device 2107 (step S2410). Although in the step S2410, the power supply to the storage device 2107 is completely cut off, the power supply to part of the storage device 2107 may be cut off so as to shift the information processing apparatus 110 to such a reduced power consumption mode in which the storage device 2107 cannot store data.

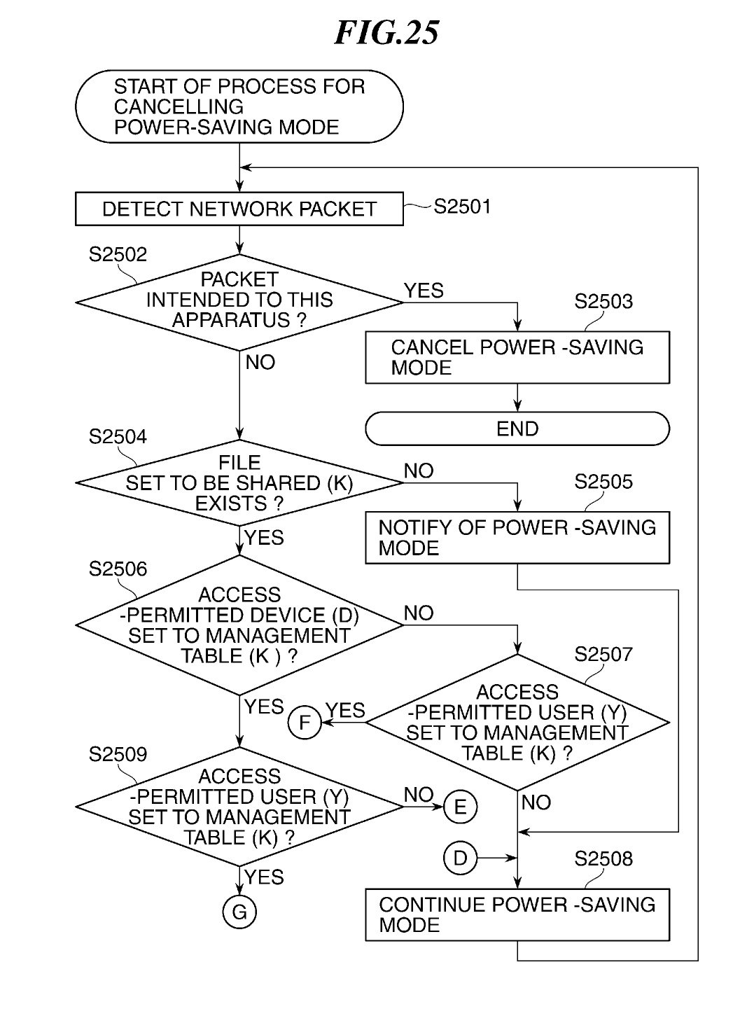

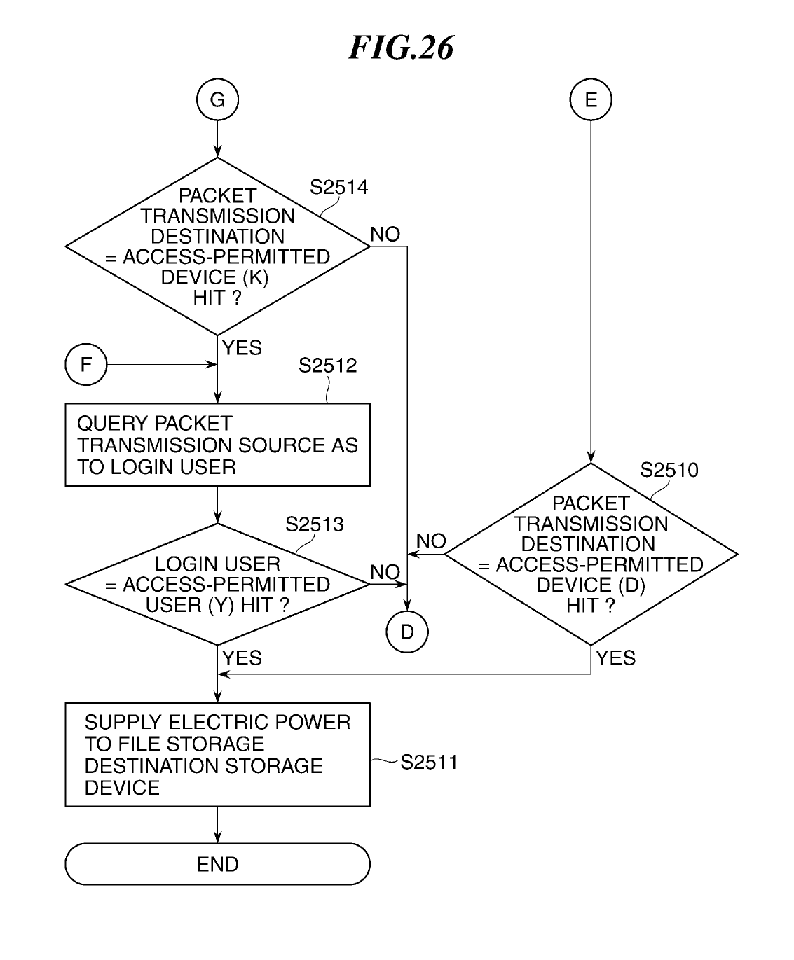

FIGS. 25 and 26 are flowcharts of a process executed by the information processing apparatus according to the third embodiment for cancelling the power-saving mode thereof.

Steps S2501 to S2505 are identical to the respective steps S1101 to S1105 described above with reference to FIG. 11 in the first embodiment.

In the step S2504, the CPU 2103 determines whether or not there is a file set to be shared. If there is a file set to be shared, the process proceeds to a step S2506. In the step S2506, the CPU 2103 checks whether or not the access-permitted device (D) is set in the data management table. Further, in steps S2507 and S2509, the CPU 2103 checks whether or not the access-permitted user (Y) is set in the data management table.

If neither of the access-permitted device (D) and the access-permitted user (Y) is set in the data management table 1400, the CPU 2103 continues the power-saving mode (step S2508). If the access-permitted device alone is set in the data management table 1400, the CPU 2103 determines whether or not an IP address or a MAC address of a transmission source of the network packet is associated with the access-permitted device set in the data management table 1400 (step S2510 in FIG. 26). If the IP address or the MAC address is not associated with the access-permitted device, the CPU 2103 continues the power-saving mode, whereas if the IP address or the MAC address is associated with the access-permitted device, the CPU 2103 supplies electric power to the storage device 2107 (step S2511), whereby preparation for the access-permitted device (D) to access the data is completed.

If the access-permitted user alone is set in the data management table 1400, the CPU 2103 requests the packet transmission source to transmit data of the login user (step S2512). Based on the data of the login user transmitted from the packet transmission source, the CPU 2103 determines whether or not the login user corresponds to the access-permitted user set in the data management table 1400 (step S2513). If the login user does not correspond to the access-permitted user, the CPU 2103 continues the power-saving mode, whereas if the login user corresponds to the access-permitted user, the CPU 2103 supplies electric power to the storage device 2107, whereby preparation for the access-permitted user (Y) to access the data is completed.

If both of the access-permitted device and the access-permitted user are set in the data management table 1400, first, the CPU 2103 determines whether or not the IP address or the MAC address of the transmission source of the network packet is associated with the access-permitted device set in the data management table 1400 (step S2514). If the IP address or the MAC address is associated with the access-permitted device, the CPU 2103 requests the packet transmission source to transmit data of the login user (step S2512). If the user information as well corresponds to the user information set in the data management table 1400, the CPU 2103 supplies electric power to the storage device 2107 (step S2511), whereby preparation for the access-permitted device and the access-permitted user to access the data is completed. If the user information does not correspond, the CPU 2103 continues the power-saving mode.

The third embodiment provides the following advantageous effects:

(1) Each data item stored in the storage device 2107 is configured as to a combination of sharing setting, an access-permitted device and an access-permitted user, and if no data stored therein is set to be shared, it is determined that there is no possibility of the data stored therein being accessed. This makes it possible to cut off the power supply to the storage device 2107 and the storage device control section 2105.

(2) If there comes to be no combination of an access-permitted device and an access-permitted user detected among external devices connected to the network 170, it is determined that there is no possibility of the stored data being accessed. This makes it possible to cut off the power supply to the storage device 2107 and the storage device control section 2105.

(3) As long as a combination of an access-permitted device and an access-permitted user is detected on the network 170, electric power is supplied to the storage device 2107 and the storage device control section 2105, and there is no need to perform a process for resuming the supply of electric power so as to read out a file. This makes it possible to quickly respond to a request for accessing the data stored in the storage device 2107.

(4) Since it is possible to determine the possibility of access to the data, similarly to the first embodiment, it is possible to reduce the number of times of unnecessary power supply and the number of times of unnecessary interruption of the power supply to the storage device 2107.

(5) As distinct from the first embodiment that designates permission to access to data on a device basis and the second embodiment that designates permission to access to data on a user basis, permission to access to data can be designated on a basis of a combination of a device and a user. This makes it possible to determine a possibility of access to a file set to be shared, in a more detailed manner. Since it possible to determine the possibility of the access in a more detailed manner, it is possible to reduce the number of times of unnecessary power supply and the number of times of unnecessary interruption of the power supply, thereby making it possible to reduce unnecessary supply of electric power.

(6) By omitting registration of the setting of either an access-permitted device or an access-permitted user, it is possible to include the operations of the first embodiment and the second embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-042223, filed Feb. 25, 2009, which is hereby incorporated by reference herein in its entirety.

What is claimed is:

1. An information processing apparatus comprising:
a communication unit configured to communicate with external devices connected to a network;
a storage device configured to store data;
an electric power control unit configured to control a state of power supply to the storage device;
a storage unit configured to store, in association with a data item stored in said storage device, identification information for identifying an external device capable of acquiring the data item;
a detection unit configured to detect whether or not the external device identified by the identification information stored in said storage unit is in a state capable of acquiring the data item stored in said storage device;
a determination unit configured to be operable when said communication unit receives an acquisition request for acquiring a data item stored in said storage device from the external device, to determine whether or not to transmit the data item associated with the acquisition request to the external device, based on the identification information stored in said storage unit in association with the data item associated with the acquisition request; and
a communication control unit configured to cause said communication unit to transmit the data associated with the acquisition request to the external device, when said communication unit receives the acquisition request and when said determination unit determines that the data associated with the acquisition request be transmitted to the external device,
wherein said electric power control unit causes electric power supplied to said storage device to be reduced, when said detection unit detects that the external device identified by the identification information is not in the state capable of acquiring the item data stored in said storage device.

2. The information processing apparatus according to claim 1, wherein said storage unit is capable of storing a plurality of items of the identification information for identifying a plurality of external devices, respectively, and
wherein said detection unit detects whether or not the plurality of external devices identified by the plurality of items of the identification information are each in a state capable of acquiring an associated data item stored in said storage device, and
wherein said electric power control unit causes the electric power supplied to said storage device to be reduced when said detection unit detects that none of the plurality of external devices identified by the plurality of items of the identification information are each in the state capable of acquiring the associated data item stored in said storage device.

3. The information processing apparatus according to claim 1, wherein said communication unit queries to the external device as to whether or not the external device identified by the identification information is in a state capable of acquiring the data item from the information processing apparatus, and
wherein said detection unit detects whether or not the external device is in the state capable of acquiring the data item from the information processing apparatus, based on a result of response of the external device to the query.

4. The information processing apparatus according to claim 1, wherein the identification information is address information for identifying the external device.

5. The information processing apparatus according to claim 1, wherein the identification information is user information for identifying a user having logged in to the external device.

6. The information processing apparatus according to claim 1, wherein the identification information includes both of address information for identifying the external device and user information for identifying a user having logged in to the external device.

7. The information processing apparatus according to claim 1, wherein said electric power control unit causes the electric power supplied to said storage device to be increased, when said detection unit detects that the external device is in the state capable of acquiring the data item stored in said storage device after said electric power control unit causes the electric power supplied to said storage device to be reduced.

8. A method of controlling an information processing apparatus including a communication unit configured to communicating with an external device connected to a network, a storage device configured to store data, an electric power control unit configured to control a state of power supply to the storage device, and a storage unit configured to store, in association with a data item stored in said storage device, identification information for identifying an external device capable of acquiring the data item, the method comprising:
detecting whether or not the external device identified by the identification information stored in the storage unit is in a state capable of acquiring the data item stored in the storage device;
determining when the communication unit receives an acquisition request for acquiring a data item stored in the storage device from the external device, whether or not to transmit the data item associated with the acquisition request to the external device, based on the identification information stored in the storage unit in association with the data item associated with the acquisition request;
causing the communication unit to transmit the data associated with the acquisition request to the external device, when the communication unit receives the acquisition request and when it is determined that the data associated with the acquisition request be transmitted to the external device; and
causing electric power supplied to the storage device to be reduced, when it is detected that the external device identified by the identification information is not in the state capable of acquiring the item data stored in said storage device.

9. A computer-readable storage medium that stores a program for causing a computer to execute a method of controlling an information processing apparatus including a communication unit configured to communicating with an external device connected to a network, a storage device configured to store data, an electric power control unit configured to control a state of power supply to the storage device, and a storage unit configured to store, in association with a data item stored in said storage device, identification information for identifying an external device capable of acquiring the data item,
wherein the method comprises:
detecting whether or not the external device identified by the identification information stored in the storage unit is in a state capable of acquiring the data item stored in the storage device;
determining when the communication unit receives an acquisition request for acquiring a data item stored in the storage device from the external device, whether or not to transmit the data item associated with the acquisition request to the external device, based on the identification information stored in the storage unit in association with the data item associated with the acquisition request;
causing the communication unit to transmit the data associated with the acquisition request to the external device, when the communication unit receives the acquisition request and when it is determined that the data associated with the acquisition request be transmitted to the external device; and
causing electric power supplied to the storage device to be reduced, when it is detected that the external device identified by the identification information is not in the state capable of acquiring the item data stored in said storage device.
